(19) United States
(12) Patent Application Publication
(10) Pub. No.: US 2015/0066226 A1
(43) Pub. Date: Mar. 5, 2015

(54) VIRTUAL PARALLEL LOAD MODULE SYSTEM

(71) Applicant: EXPERIUM TECHNOLOGIES, LLC, Upper Marlboro, MD (US)

(72) Inventor: Lance Palatini, Morris Plains, NJ (US)

(73) Assignee: EXPERIUM TECHNOLOGIES, LLC, Upper Marlboro, MD (US)

(21) Appl. No.: 14/017,353

(22) Filed: Sep. 4, 2013

(51) Int. Cl. G05F 1/625; G05B 15/02

(52) U.S. Cl. CPC G05F 1/625; G05B 15/02
USPC 700/295

(57) ABSTRACT

An electronic load module system for testing voltage sources, such as power supplies, batteries, and fuel cells, is characterized by its ability to combine multiple load modules into a single virtual load for use with a first voltage source while simultaneously allowing other load modules in the same system to independently provide a load to an additional voltage source. The load modules may be combined in various configurations without altering the internal physical structure of the system. The system includes a first load module connected with the terminals of the voltage source and an associated control module connected with the first load module to supply a drive signal to the load module. The load system also includes a second load module. The second load module may be connected with the terminals of the voltage source in parallel with the first load module, or the second load module may be connected with the terminals of a second voltage source. A second control module is connected with the second load module to supply a drive signal to the second load module. The multiple load modules and control modules may be mounted in a single chassis.

### BACKGROUND OF THE INVENTION

A load module is an electronically activated system that creates an electrical current load on a voltage source by using the current control capacity of a field effect transistor or fixed resistive, capacitive or inductive elements switched across the voltage source. Such a load module is often used in the testing of voltage sources, such as power supplies, batteries, and fuel cells. A load module is advantageous as it can simulate numerous types of electrical characteristics on the voltage source being tested. A load module may comprise multiple elements connected in parallel and sharing current equally.

A transistorized load module system simulates the current drawn by a device on an electronic power source by using the current control capacity of a field effect transistor (FET). A field effect transistor is an elemental electrical device where the current through the device is controlled by the voltage applied to a specific terminal. An FET-based load module may generally consist of a set of FETs mounted in parallel and controlled by adjusting the gate voltage to produce the desired current flow through the system.

The present invention relates to a virtual parallel load module system in which a plurality of loads can be automatically or selectively connected across a voltage source to control the current supplied to the source.

### BRIEF DESCRIPTION OF THE PRIOR ART

Load banks are well known in the patented prior art as evidenced by the Fong U.S. Pat. No. 7,683,553 which discloses a current control circuit in which matching drive currents through a plurality of parallel loads are set. A regulated voltage is provided to one terminal of a capacitor and to one terminal of each load and provides a source of current for the loads. The Tanner U.S. Pat. No. 7,479,713 discloses a fixed output linear voltage regulator used to drive a plurality of loads connected in parallel to control power dissipation. The Locker et al US patent application publication No. 2005/0134248 discloses a load bank having an infinitely variable load and a programming and control unit which is used to control the current flow through a power resistor. The Zhao et al US patent application publication No. 2012/0249094 discloses a load module, which may include a number of sub-sea loads and a number of modular stacked power converters.

In addition, electronic load systems utilizing FETs are known in the prior art. For example, U.S. Pat. Nos. 6,324,042 and 6,697,245, both to Andrews, disclose an electronic load for the testing of electrochemical energy conversion devices. These patents disclose a device in which analog and digital feedback may be provided to adjust the control signal to the FETs to ensure that each remains within its individual safe operating area.

While the prior devices operate satisfactorily, they lack versatility in that they are not capable of effectively combining multiple load modules into a single virtual load. In addition, the prior art devices are not capable of combining some of the load modules into a single virtual load for use with a first voltage source while simultaneously allowing other load modules in the same system to independently provide a load to an additional voltage source. The present invention was developed in order to overcome these and other drawbacks of the prior art by providing a load module system in which load modules may be combined in various configurations without altering the internal physical structure of the system.

### SUMMARY OF THE INVENTION

Accordingly, it is a primary object of the invention to provide a load system for creating a current to be applied to the terminals of a voltage source. The system includes a first load module connected with the terminals of the voltage source and an associated control module connected with the first load module to supply a drive signal to the load module. In embodiments of the invention, the load module may include a field effect transistor. The load system also includes a second load module. The second load module may be connected with the terminals of the voltage source in parallel with the first load module, or the second load module may be connected with the terminals of a second voltage source. A second control module is connected with the second load module to supply a drive signal to the second load module. The multiple load modules and control modules may be mounted in a single chassis.

Components of the load module system are connected with a communication network for communicating information regarding characteristics of the setup of the load system to the control modules. The communication network may be a wired or wireless network. In addition, the system may include a processor unit communicating with the control modules via the communications network in order to configure the control modules. The processor unit may be a computer programmed with an interface and setup instructions stored in nonvolatile memory. The system may also include a manual controller connected with the communications network to manually configure the control modules.

The system may also include a database connected with a computer or directly connected with the communications system. The database can be used to store information regarding characteristics of the control modules. In embodiments of the invention, the processor unit sends control information to the control modules based at least in part upon the information stored in said database.

A further embodiment of the invention includes a method for configuring a load module system for creating a current to be applied to the terminals of a voltage source. In accordance with the method, a first load module is connected with the terminals of said voltage source. A first value associated with a characteristic of the first module is stored in a non-volatile memory. An additional load module is connected with the terminals of said voltage source in parallel with the first load module, and an additional value associated with a characteristic of the additional module is stored in a non-volatile memory. A user interface is utilized to input a setup configuration indicating that the first load module is connected in parallel with the second load module. A combined value related to the first and additional values is then entered into and stored in non-volatile memory.

The method may further include the step of inputting a desired current draw for the load system into the user interface. The output of each individual load module may then be determined by counting the number of load modules connected in parallel to the terminals of the voltage source and dividing the desired total current draw by the number of load modules. In an embodiment of the invention, the stored values may be binary integers, which may be stored in a database.

### BRIEF DESCRIPTION OF THE FIGURES

Other objects and advantages of the invention will become apparent from a study of the following specification, when viewed in the light of the accompanying drawing, in which:

FIG. 1 is a schematic representation of a field effect transistor used as a load device for a voltage source;

FIG. 2 is a block diagram of a transistorized electronic load system for a voltage source;

FIG. 3 is a block diagram of a plurality of load modules connected with a single communications bus;

FIG. 4 is a block diagram of a plurality of load modules connected with a single communications bus with multiple load modules connected with a single voltage source;

FIG. 5 is a block diagram of a plurality of load modules connected with a single communications bus with each load module connected with a single voltage source

FIG. 6 is a block diagram of a plurality of load modules connected with a single communications bus with multiple load modules connected with a single voltage source;

FIG. 7 is a block diagram of a further embodiment of a plurality of load modules connected with a single communications bus with multiple load modules connected with a single voltage source; and

FIG. 8 is a flow diagram illustrating a method for controlling a load module system in accordance with embodiments of the present invention.

### DETAILED DESCRIPTION

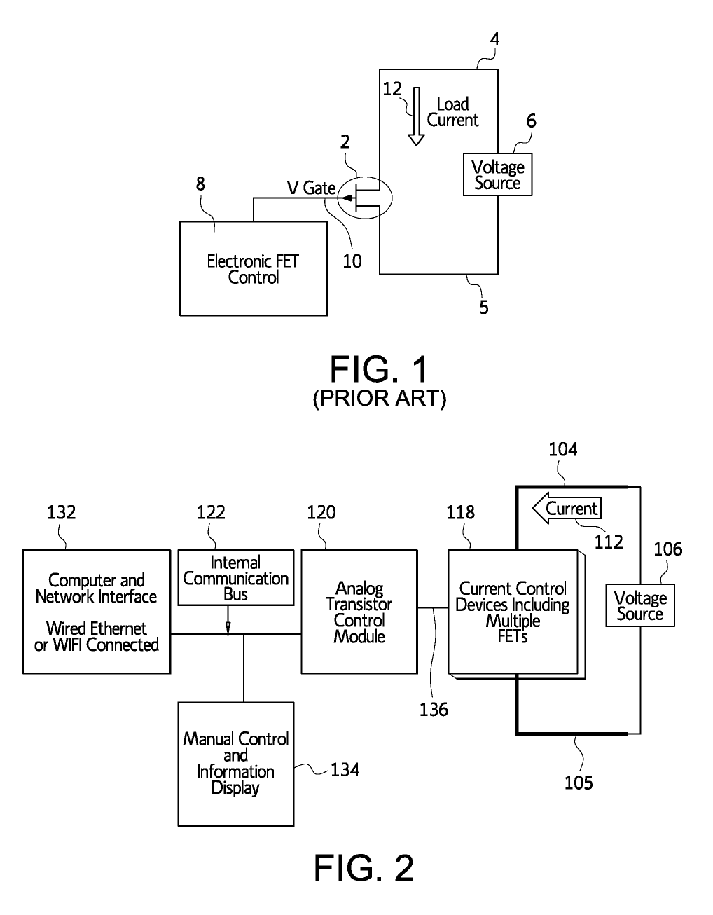

FIG. 1 shows load systems according to the prior art. In FIG. 1 there is shown a field effect transistor (FET) 2 connected across the terminals 4, 5 of a voltage source 6. The transistor is an electric device where the current through the device is controlled by the voltage applied to a specific terminal. In FIG. 1, the load current through two terminals of the transistor 2 is proportional to the voltage applied to the gate terminal. A current 12 passes between a source terminal 4 and a drain terminal 5. This current 12 may be referred to as the drain current (I_{drain}). The current 12 is proportional to a voltage applied to gate terminal 10. This voltage may be referred to as the gate voltage (V_{gate}). Accordingly, the FET can be modeled by the following simple equation:

I_{drain}=Constant*V_{gate} [Eq. 1]

In embodiments of the invention, the gate terminal 10 is connected with an electronic FET controller 8. The controller 8 includes a digital to analog converter that provides the gate voltage (V_{gate}) to the gate terminal 10. In this manner, the current 12 across the source 4 and drain 5 terminals can be controlled. The digital to analog converter is connected with a processor that controls the output of the digital to analog converter.

Referring to FIG. 2, the load system according to an embodiment of the invention will be described. The load system is used to generate a controlled current across the terminals 104, 105 of a voltage source 106. A load bank 118 is connected in parallel with the source terminals 104, 105. As will be developed below, the load bank includes a plurality of current control devices or loads that are selectively connected with the source terminals. The loads are of the field effect transistor type as shown in FIG. 1. A controller 120 is connected with the load bank for selecting at least one load for connection with the source terminals. The controller is in the form of an analog transistor module. A communication network 122 is connected with the loads for communicating status and command information between the loads. The communication network is either a wired or wireless network.

As further illustrated in FIG. 2, a control voltage (V_{drive}) 136 is applied to the load bank 118. The control voltage is created by a digital to analog voltage converter (DAC) that forms part of the control module 120. The control module 120, and its included DAC, are connected through a communications bus 122 to a computer network interface 132, which is in turn connected with a system microprocessor. In this manner the system microprocessor sends a binary digital pattern (V_{binary}) to the control module 120, which then generates the appropriate V_{gate} signal (FIG. 1) for each FET device 2 of the load bank 118. V_{gate} can be expressed by the following equation:

V_{gate}=Constant*V_{binary} [Eq. 2]

Combining Eq. 1 with Eq. 2, it can be seen that the current across an FET 2 is proportional to the binary digital pattern:

I_{drain}=Constant*V_{binary} [Eq. 3]

As discussed above, the user may control the applied load current 112 using a processor connected with a computer network interface 132. Alternatively, the user may control the current 112 through the use of a manual control interface 134 that is also connected with the communication network 122, or which may be connected directly to the control module 118.

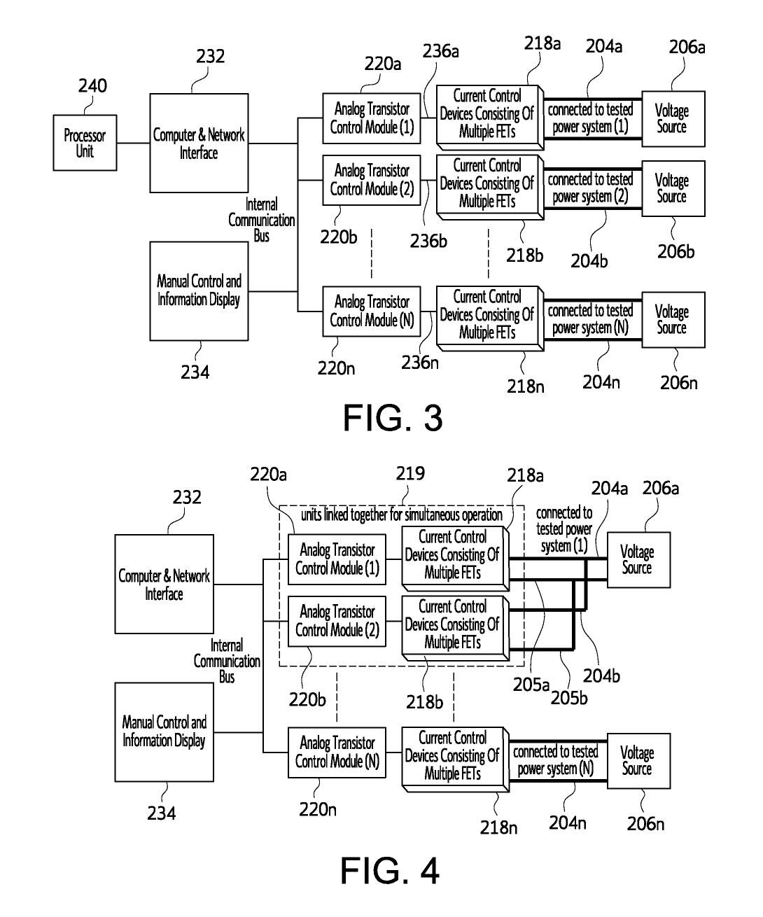

As illustrated in FIG. 3, multiple load modules 218a, 218b to 218n are used in the same load bank system. These load modules are each connected by source terminals 204a, 204b to 204n to a separate voltage source 206a, 206b to 206n. Each load module 218a, 218b, 218n is also connected with a separate control module 220a, 220b to 220n. These control modules are used to independently apply a control voltage 236a, 236b to 236n to load modules 218. Multiple control modules 220 are connected with an internal communication bus 222. This communication bus 222, in turn, connects multiple control modules 220 to a single computer network interface 232 or to a single manual control interface 234. In this manner, multiple load modules 218 can be installed in a single chassis to provide the ability to test multiple power systems simultaneously with a single device using a single processor unit 240 to the network interface 232. The processor unit 240 comprises a purpose built microprocessor control device or a general computer having appropriate programming instructions stored in a non-volatile memory.

Referring to FIG. 4, in a system using multiple load modules, it is desirable to control multiple load modules simultaneously so that these connected modules operate and respond as a single unit. For example, a voltage source 206a is connected in parallel to two load modules 218a, 218b. In this embodiment, the source terminal 204a of the first load module 218a is connected in parallel with the source terminal 204b of a second load module 218b Likewise, the drain terminal 205a of the first load module 218a is connected in parallel with the drain terminal 205b of a second load module 218b. With the load modules 218a, 218b and their associated control modules 220a, 220b connected in this manner, the processor unit 240 or manual control interface 234 may be setup through the network interface 232 and communication bus 222 to treat the parallel load modules 218a, 218b as a single virtual load module 219. Additional load modules 218n may be used simultaneously to provide a load for additional voltage sources 206n.

Connecting multiple individual modules together as shown in FIG. 4 requires a high degree of electrical interaction between the units. However, this connection must be performed in a manner that does not require alteration of the internal physical connections between the various components in the system chassis. It is also desirable that the various modules are connected in any possible combination of two or more modules leading to many potential permutations.

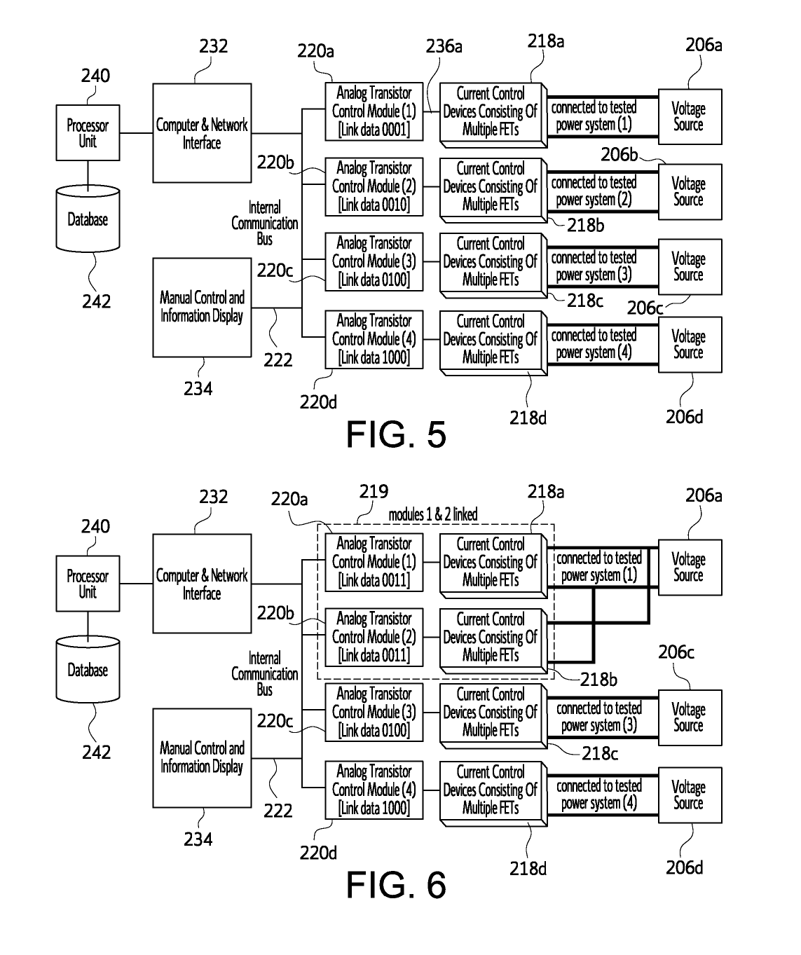

As illustrated in FIG. 5, embodiments of the present invention address control of the various potential combinations using a database of the load modules present in the system. The database 242 is connected in a known manner to the processor unit 240. Alternatively, the database is also connected directly to the communications bus 222. As discussed below, the database is configured to store information regarding load modules in non-volatile memory.

FIG. 5 shows an exemplary system including four load modules 218a, 218b, 218c, 218d and four corresponding control modules 220a, 220b, 220c, 220d. However, it should be understood that the present invention contemplates a system comprising more than the four load modules shown. The database 242 contains system and operational information regarding the individual modules 218 including specific variables to describe how the modules are physically linked to each other in the system. A database element LINK DATA is a binary value used to associate the connections between the individual modules with the desired setup.

The example of FIG. 5 shows the status of a system in which each of the load modules 218a, 218b, 218c, 218d is respectively connected with a separate voltage source 206a, 206b, 206c, 206d. The LINK DATA element in the database is set for each load module according to the specified setup. In this exemplary setup, the LINK DATA binary value of 0001 is associated with the control module 220a connected with a first load module 218a for control of a first voltage source 206a. In a like manner, the LINK DATA value of 0010 is associated with the control module 220b while LINK DATA value 0100 is associated with control module 220c and LINK DATA value 1000 is associated control module 220d.

FIG. 6 illustrates an example in which two load modules 218a, 218b are connected in parallel to one voltage source 206a. The remaining load modules are each connected with a separate voltage source: load module 218c with voltage source 206c and load module 218d with voltage source 206d. To coordinate this setup, the LINK DATA values associated with the control modules 220a, 220b and with the two linked load modules 218a, 218b are changed in the database 242. In this example, LINK DATA value 0011 is associated with both control modules. This value 0011 results from an additive combination of the LINK DATA values associated with the unlinked control modules, 0001 associated with the first module 220a and 0010 associated with the second module 220 as shown in FIG. 5. This allows the system to treat the combined load modules as a single virtual load module 219. The LINK DATA value associated with the remaining, independent control modules remains the same: 0100 associated with control module 220c and 1000 associated with control module 220d.

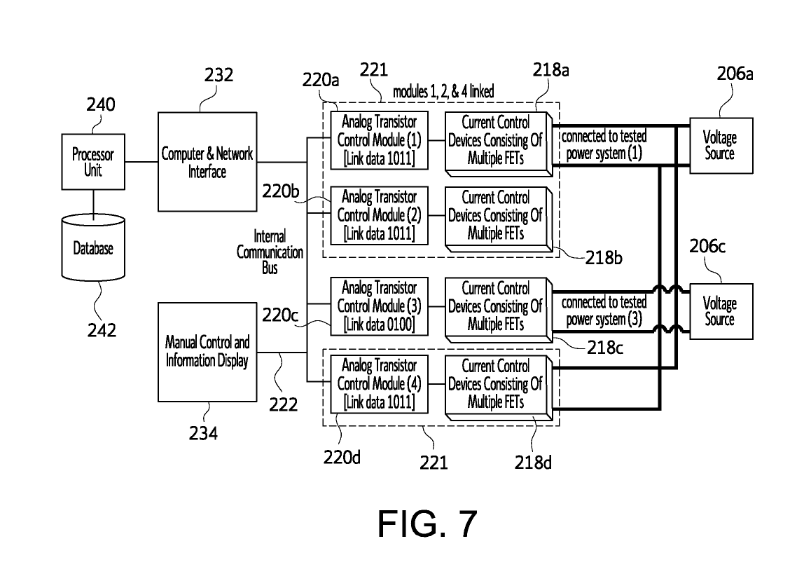

FIG. 7 illustrates a further example in which three load modules 218a, 218b, 218d are connected in parallel to one voltage source 206a. The remaining load module 218c is connected with a separate voltage source 206c. To coordinate this setup, the LINK DATA values associated with the three combined control modules 220a, 220b, 220d are changed in the database 242. In this example, LINK DATA value 1011 is associated with all three control modules. The value 1011 results from an additive combination of the LINK DATA values associated with the unlinked control modules, 0001 associated with the first module 220a: 0010 associated with the second module 220b and 1000 associated with the third module 220d. This allows the system to treat the combined load modules as a single virtual load module 221. The LINK DATA value associated with the remaining, independent control module remains the same: 0100 associated with control module 220c.

Operation of embodiments of the present invention may include the following steps. During startup or at anytime thereafter the system operator designates which modules are to operate as linked units by executing a LINK command either via a programming interface associated with the processor unit 240 or the manual user interface 234. The format of this command is as follows:
LINK <module number>,<link data>.
   The module number is the internal system address of the load module (typically 1 through 8), and the link data (LINK DATA value), while interpreted by the system in binary notation, may be provided by the user in decimal notation.

In a first example, as illustrated by FIG. 6, where load modules 218a and 218b are linked, the user would execute the command: LINK 1, 3. This command would cause the system to load the database entries for the first two modules 218a, 218b with the binary value 0011, which is three in decimal notation and the additive sum of the individual LINK DATA values: 0001 for module 218a and 0010 for module 218b.

In a second example as illustrated by FIG. 7, where load modules 218a, 218b and 218d are linked, the user would execute the command: LINK 1, 11. This command would cause the system to load the database entries for modules 218a, 218b and 218d with the binary pattern 1011, which is eleven in decimal notation and the additive sum of the individual LINK DATA values: 0001 for module 218a, 0010 for module 218b and 1000 for module 218d.

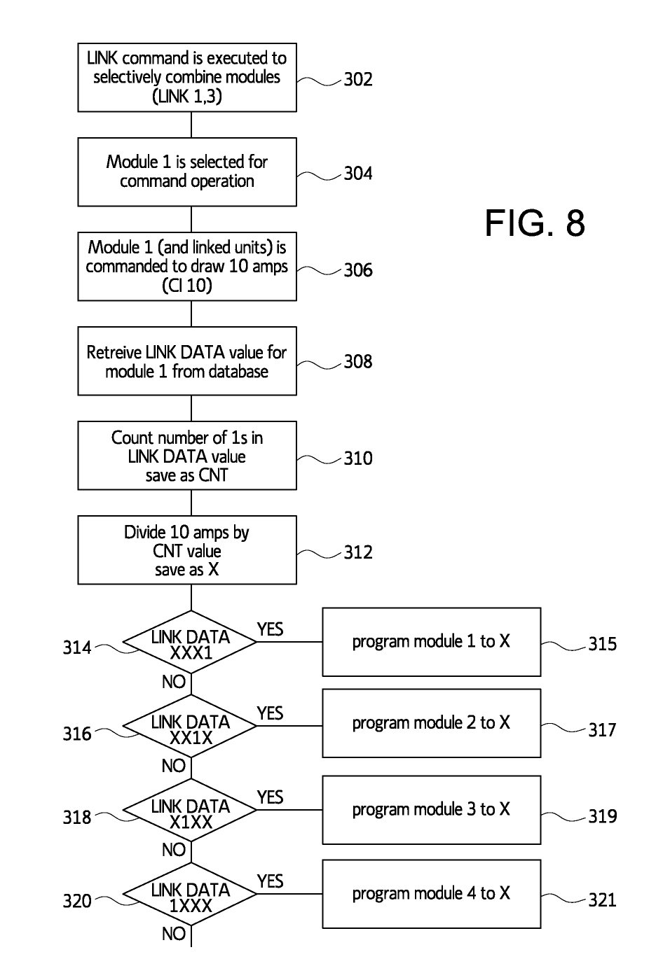

FIG. 8 is a flow diagram of the control process of the example illustrated in FIG. 6. In a first step 302, the user executes a LINK command to combine modules 218a and 218b. The first module 218a is then selected for command operation, step 304. Next, the first module 218a and the linked module 218b are commanded to draw 10 Amps, step 306. In step 308, the system then retrieves the LINK DATA value for the combined modules from the database 242. In this example, the LINK DATA value would be 0011. The system then counts the number of “1s” in the binary value; in this example there are two, step 310. This number, two in this example, is saved as a variable “CNT.” The total desired output, 10 Amps, is then divided by the value of the variable CNT, step 312. This gives the desired output for each individual module combined together to form the virtual module 219. This individual module output is saved as a variable “X”, which in this case would equal 5 Amps (ten divided by two).

The system then goes through a series of decision steps in order to determine the output to use for each of the combined load modules. In the first decision step 314, the system determines whether the LINK DATA value has a “1” in the binary digit associated with the first load module 218a. In this example, the LINK DATA value is 0011, and there is, therefor, a “1” in the corresponding digit. Accordingly, the control module 220a for load module 218a is programmed to carry a load of 5 Amps in step 315. Proceeding to step 316, the same analysis is undertaken. Again, the LINK DATA value is 0011, and there is, therefor, a “1” in the binary digit corresponding to load module 218b. The control module 220b for load module 218b is programmed to carry a load of 5 Amps in step 317.

Moving to the following step 318, the same analysis is performed. In this example, the binary digit corresponding to load module 218c does not include a “1.” Accordingly, the control module 220c corresponding to load module 218c is not programmed to carry a load Likewise, following the analysis performed in step 320, the control module 220d corresponding to load module 218d is not programmed to carry a load.

While the preferred forms and embodiments of the invention have been illustrated and described, it will be apparent to those of ordinary skill in the art that various changes and modifications may be made without deviating from the inventive concepts set forth above.

What is claimed is:

1. A load system for creating a current to be applied to the terminals of a voltage source, comprising
(a) a first load module connected with the terminals of said voltage source;
(b) a first control module connected with said first load module to supply a drive signal to said first load module;
(c) a second load module selectively connected with the terminals of said voltage source in parallel with said first load module or to the terminals of a second voltage source;
(d) a second control module connected with said second load module to supply a drive signal to said second load module; and
(e) a communication network connected with said first control module and said second control module for communicating information regarding a characteristic of the setup of said load system to said control modules.

2. A load system as defined in claim 1, wherein said first load module comprises a field effect transistor.

3. A load system as defined in claim 1, wherein said communication network comprises a wired or wireless network.

4. A load system as defined in claim 3, and further comprising a processor unit communicating with said communication network and said first and second control modules to configure said first and second control modules.

5. A load system as defined in claim 4, wherein said processor unit comprises a computer.

6. A load system as defined in claim 3, and further comprising a manual controller connected with said communications network to manually configure said first and second control modules.

7. A load system as defined in claim 4, and further comprising a database connected with said communications network for storing in a non-volatile memory information regarding characteristics of said first and second load modules.

8. A load system as defined in claim 7, wherein said database is connected with said processor unit.

9. A load system as defined in claim 8, wherein said processor unit sends control information to said first and second control modules based at least in part upon the information stored in said database.

10. A load system as defined in claim 1, and further comprising a chassis at least partially enclosing said first and additional load modules.

11. A method for configuring a load module system for creating a current to be applied to the terminals of a voltage source, comprising the steps of
(a) connecting a first load module with the terminals of said voltage source;
(b) storing a first value associated with a characteristic of said first module in a non-volatile memory;
(c) connecting at least one additional load module with the terminals of said voltage source in parallel with said first load module;
(d) storing an additional value associated with a characteristic of said additional module in a non-volatile memory;
(e) inputting into a user interface a setup configuration indicating that said first load module is connected in parallel with said second load module; and
(f) storing a combined value in a non-volatile memory, wherein said combined value is related to said first and additional values.

12. A method as defined in claim 11, and further comprising the step of inputting into said user interface a desired current draw for said load system.

13. A method as defined in claim 12, and further comprising the step of counting the number of load modules connected in parallel with the terminals of said voltage source.

14. A method as defined in claim 13, and further comprising the step of dividing said desired current draw by said number of load modules to determine the desired output of each of said first and additional load modules.

15. A method as defined in claim 14, wherein said first, additional and combined values are binary integers.

16. A method as defined in claim 11, wherein said non-volatile memory comprises a database.

17. A method as defined in claim 11, wherein said user interface comprises a computer.

18. A method as defined in claim 11, wherein said user interface comprises a manual controller for manually selecting a combination of load modules connected with said source terminals.
